(19) United States
(12) Patent Application Publication
(10) Pub. No.: US 2014/0226213 A1
(43) Pub. Date: Aug. 14, 2014

(54) REMOVABLE DISPLAY FOR OPTICAL DEVICE

(71) Applicant: EXELIS, INC., Mclean, VA (US)

(72) Inventors: PARISSA FATHALIPOUR, Roanoke, VA (US); Rawlin H. Brown, Salem, VA (US); Gregory S. Bandy, Roanoke, VA (US); Eric Garris, Salem, VA (US)

(73) Assignee: Exelis, Inc., Mclean, VA (US)

(21) Appl. No.: 13/766,108

(22) Filed: Feb. 13, 2013

(51) Int. Cl. G02B 27/01

(52) U.S. Cl. CPC G02B 27/01
USPC 359/630

(57) ABSTRACT

An optical apparatus for viewing one or more images including (i) an optical device for enhancing the one or more images and having a surface defining mechanical threads; (ii) a display device having a display for presenting information that is removably attached to the optical device, the display device including a surface defining mechanical threads for mating with the mechanical threads of the optical device; and (iii) a lock ring that is mounted to the mechanical threads of the optical device, said lock ring being positioned between the display device and the optical device, wherein the lock ring is rotatably positioned on the mechanical threads of the optical device to move toward and bear on a surface of the display device in order to either limit or prevent the display device from further rotation on the mechanical threads of the optical device.

### FIELD OF THE INVENTION

The present invention is directed to a head-up display device that is removably attached to an optical device.

### BACKGROUND OF THE INVENTION

There exists head-up display (HUD) devices for displaying information on a transparent display. These HUD devices present data without requiring users to look away from their usual viewpoints. Most conventional HUD devices are either see-through or obscured. One problem with conventional HUD devices, however, is that they may not be used in conjunction with other optical devices (e.g., night vision devices) without requiring a device to be positioned on each of the user's eye. This positioning is not ideal, because it requires the user to mentally perform the work of overlaying the images of HUD device upon the image of the optical device. In view of the foregoing challenges, described hereinafter is a way to an optical device to accommodate a HUD device.

### SUMMARY OF THE INVENTION

According to one aspect of the invention, an optical apparatus for viewing one or more images is provided. The optical apparatus includes (i) an optical device for enhancing the one or more images and having a surface defining mechanical threads; (ii) a display device, which includes a display for presenting information, that is removably attached to the optical device, the display device including a surface defining mechanical threads for mating with the mechanical threads of the optical device; and (iii) a lock ring that is mounted to the mechanical threads of the optical device, said lock ring being positioned between the display device and the optical device, wherein the lock ring is rotatably positioned on the mechanical threads of the optical device to move toward and bear on a surface of the display device in order to either limit or prevent the display device from further rotation on the mechanical threads of the optical device.

According to another aspect of the invention, a method of retrofitting an optical device comprises the steps of coupling a display device, which has a display for presenting information, to the optical device by engaging mechanical threads on the display device with mechanical threads on the optical device; and rotating a lock ring that is positioned on the mechanical threads of the optical device toward the display device to either limit or prevent the display device from further rotation on the mechanical threads of the optical device.

### BRIEF DESCRIPTION OF THE DRAWINGS

The invention is best understood from the following detailed description when read in connection with the accompanying drawings, with like elements having the same reference numerals. Included in the drawings are the following figures:

FIG. 1 depicts a side view of an optical apparatus of the present invention comprising an optical device and a display device that is removably mounted to the optical device.

FIG. 2 depicts an enlarged view of the circled portion of the optical apparatus depicted in FIG. 1.

FIGS. 3A-3D depict exemplary steps of retrofitting the display device of FIG. 1 onto the optical device of FIG. 1, which is initially fitted with an eyepiece. Specifically, FIG. 3A depicts a perspective view of an eyepiece mounted to the optical device of FIG. 1. FIG. 3B depicts the eyepiece being detached from the optical device. FIG. 3C depicts the display device being assembled onto the optical device. FIG. 3D depicts the display device assembled onto the optical device of FIG. 1.

FIG. 4 depicts another perspective view of the optical apparatus of FIG. 1.

### DETAILED DESCRIPTION OF THE INVENTION

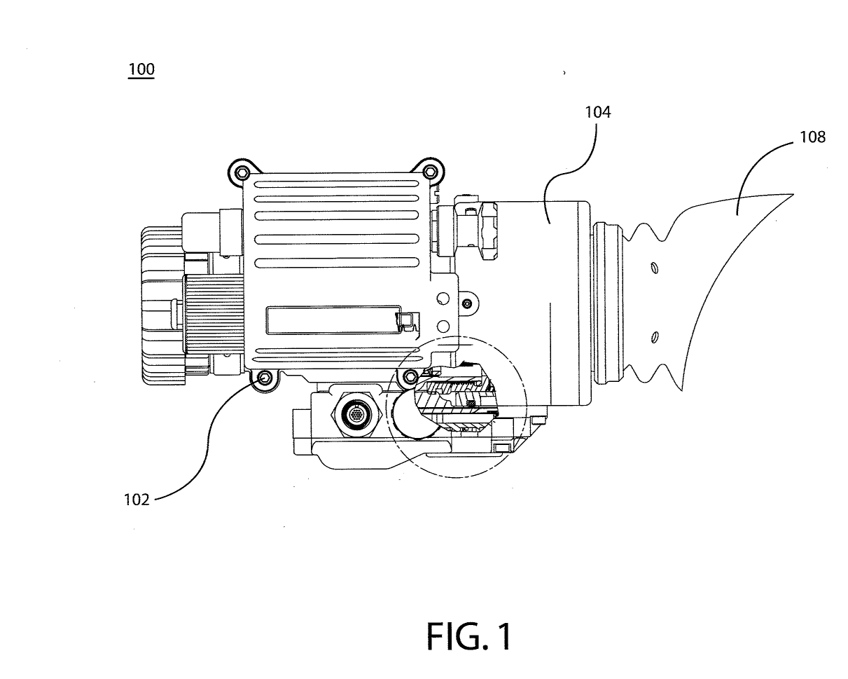

Referring generally to the overall assembly of optical apparatus 100, the apparatus 100 of the present invention generally includes an optical device 102, and a display device 104 that is removably mounted to the optical device 102. In FIG. 1, it is shown that the display device 104 includes an eyecup 108, however, the eyecup 108 is omitted from the remaining figures.

Optical device 102 of the present invention is a device used to assist a user in viewing and/or capturing images. In a preferred embodiment, optical device 102 may be a device for viewing images at night, e.g., a night vision monocular. In other embodiments, optical device 102 may be used as a camera, a telescope, a microscope, or any other suitable device for assisting the user in viewing and capturing images. Optical device 102 of the present invention may function as a stand-alone device. Alternatively, optical device 102 may require or allow additional devices to be attached to optical device 102 to provide additional functionality. For example, as discussed below, display device 104 is a HUD device that may be attached to optical device 102 to provide head-up functionality.

As indicated above, display device 104 is removably attached to optical device 102. In a preferred embodiment, display device 104 may be a head-up display (HUD) device. In one embodiment of the present invention, display device 104 (as a HUD device) may include a transparent display for presenting data. The presented data may include, for example, spatially correlated information and navigational information. Further, display device 104 may display an augmented reality to the user. Additionally, or in conjunction with the above features, display device 104 may provide applications (“apps”) relating to optical device 102. As indicated above, the data presented on display device 104 may be related to real-time information. Alternatively, the data presented on display device 104 may be other than real-time information, e.g., it may have been previously calculated. A complete description of HUD functionality is beyond the scope of this document. One of ordinary skill in the art will understand the many uses and configurations of HUD devices.

As depicted in FIG. 1, display device 104 and optical device 102 may be monocular devices. Further, display device 104 may be attached to optical device 102 such that display device 104 is substantially in front of optical device 102 so that the display device 104 can be presented before a user's eye. In such an alignment, a single eye of a user may be used to view images of optical apparatus 100. In this embodiment, the image presented by display device 104 will be overlaid upon the image produced by optical device 102. This configuration provides an advantage over a conventional optical apparatus because it alleviates the user from having to mentally overlay the image of display device 104 upon the image provided by optical device 102.

In one embodiment, the information displayed by display device 104 will be presented using light, e.g. beams of light, rays of light, etc. This light, if left unencumbered, may be detected by those other than the user of optical apparatus 100. Such detection may be problematic, because activities of users of certain embodiments of optical apparatus 100 may require that the apparatus be undetectable in low-light situations. A user of one embodiment of the present invention, for example, may be covertly using optical apparatus 100 as a night-vision goggle. In such cases, it would be counterproductive, and perhaps dangerous, for optical apparatus 100 to emit visible light that can be detected by those other than user of optical apparatus 100. To prevent such situations, display device 104 (as well as other devices of optical apparatus 100) may provide light security. That is, optical apparatus 100, and more particularly, display device 104 and optical device 102, may be configured to ensure that a limited amount of light (and, preferably, no light) be detectable by those other than the user of optical apparatus 100.

In one embodiment, depicted in FIG. 1, eyecup 108 may be attached to display device 104 to provide light security. Eyecup 108 may be constructed of a hard material, flexible material, or any other type of suitable material for forming an eyecup 108. Eyecup 108 is configured to press onto a user's face, thereby precluding light from being emitted beyond display device 104, such that the light is not detectable outside the display of optical apparatus 100. Thus, in one embodiment of the present invention, those other than the user of the optical apparatus 100 are prevented from detecting light that is emitted from optical apparatus 100. As indicated above, eyecup 108 is only one way to provide light security with respect to optical apparatus 100. Suitable other methods for providing light security, i.e., dimming the visible light or using different shades of visible light, will be understood by those skilled in the art.

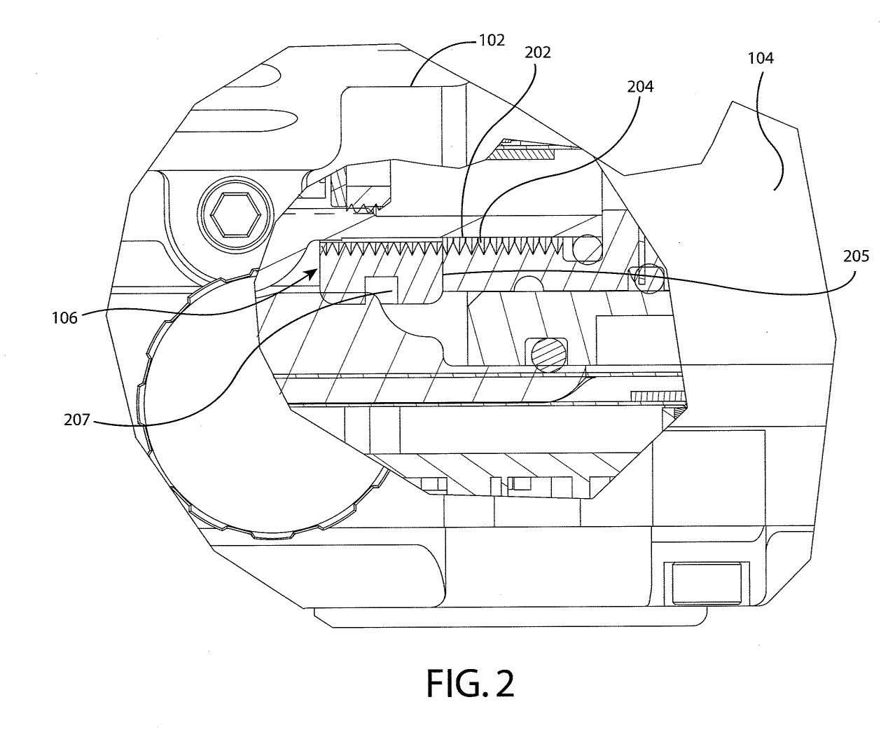

FIG. 2 depicts a detailed view of the circled portion of optical apparatus 100 in FIG. 1. In particular, FIG. 2 depicts the mechanism for attaching, and detaching, display device 104 to the housing of optical device 102. More specifically, the housing of optical device 102 includes an exterior surface that includes mechanical threads 202. An annular lock ring 106 includes interior threads that engage with mechanical threads 202 of optical device 102. The lock ring 106 may be referred to in the art as a lock nut or a jam nut. An interior surface of the housing of display device 104 includes mechanical threads 204. The mechanical threads 204 of display device 104 may also be referred to herein as a connector. Like the threads of the lock ring 106, the mechanical threads 204 of the display device 104 are also engaged with mechanical threads 202 of optical device 102.

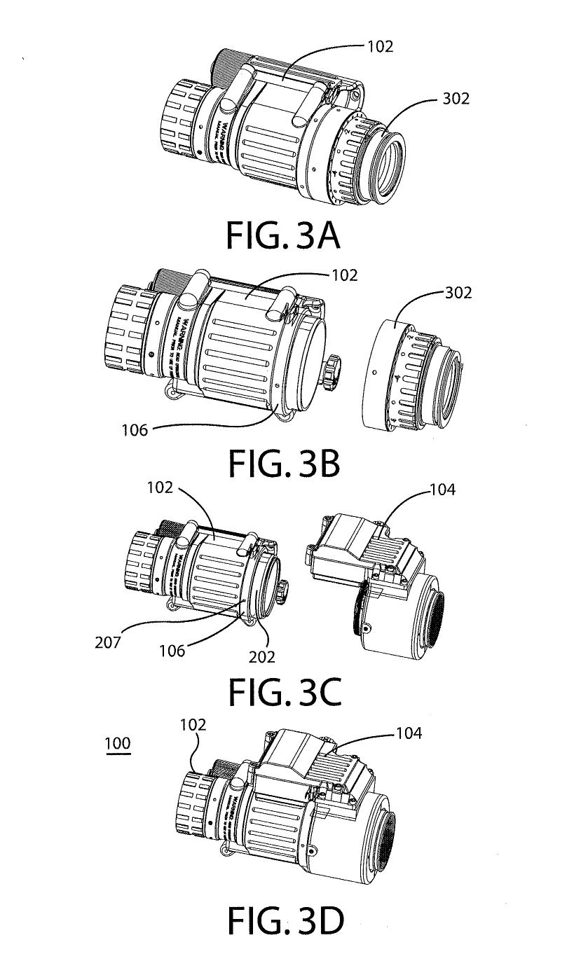

FIGS. 3A-3D depict exemplary steps of retrofitting the display device 104 of FIG. 1 onto the optical device 102 of FIG. 1, which is initially fitted with an eyepiece 302. As display devices, such as head-up displays, have gained in popularity, there exists a need to incorporate a head-up display into an existing optical device, such as a night vision monocular. The existing optical device, such as the optical device 102 shown in FIG. 3A, may be fitted with a detachable eyepiece 302. When attached to optical device 102, eyepiece 302 enhance image(s) presented by optical device 102.

FIG. 3A depicts a perspective view of the eyepiece 302 mounted to the optical device 102 of FIG. 1. Prior to attaching display device 104 onto optical device 102, eyepiece 302 must be removed.

FIG. 3B depicts the eyepiece 302 being detached from the optical device 102. Optical device 102 includes mechanical threads 202 that are engaged with interior threads (not shown) of eyepiece 302. Using the devices' respective threading, eyepiece 302 is rotated off of optical device 102 to detach those components from each other, as shown in FIG. 3B.

FIG. 3C depicts display device 104 being assembled onto the optical device 102. To attach the display device 104 to optical device 102, the lock ring 106 is first threaded onto mechanical threads 202 of optical device 102 (assuming that the lock ring 106 is not already attached to the optical device 102). The internal threading 204 of display device 104 is then threaded onto the mechanical threads 202 of optical device 102 until a surface 205 of display device 104 bears on a surface of lock ring 106 (as shown in FIG. 2). The lock ring 106 is then rotated further toward the bearing surface 205 of display device 104 to prevent display device 104 from unintentionally disengaging (i.e., backing out) from optical device 102. Openings 207 are defined on the perimeter of the lock ring 106 to accommodate a spanner wrench (not shown) that can be used to rotate the lock ring 106.

To detach display device 104, the lock ring 106 is rotated in an opposite rotational direction to separate lock ring 106 from display device 104. The lock ring 106 remains captivated to optical device 102. Thereafter, display device 104 is rotated in an opposite rotational direction to detach display device 104 from optical device 102. Display device 104 may be removably attached and/or locked to optical device 102 using other methods and devices not described above or depicted in FIG. 2, e.g., clips, clamps, fasteners, springs, knobs, adhesives, etc. Those skilled in the art will recognize other suitable ways in which display device 104 may be attached and locked to optical device 102.

FIG. 3D depicts display device 104 assembled onto the optical device 102 to form optical apparatus 100. As depicted in FIG. 3D, display device 104 is attached to optical device 102 such that display device 104 is aligned substantially in front of optical device 102. Thus, display device 104 and optical device 102 may share the same viewing space. In this embodiment, display device 104 may lay information over an image provided by optical device 102. This is one advantage over conventional optical apparatuses, because it does not require the user to mentally overlay the information upon the image provided by the optical image. Alternatively, optical device 102 and display device 104 may present distinct images that are not overlaid upon each other.

FIGS. 3A-D depict embodiments of optical apparatus 100 wherein optical device 102 is detached from eyepiece 302 and thereafter attached to display device 104. Those skilled in the art, however, will understand that many other embodiments of the present invention may exist. Optical device 102, for example, may attach to and detach from other devices besides eyepiece 302 and display device 104. Also, or alternatively, optical device 102 may simultaneously attach to display device 104 and other devices, including eyepiece 302.

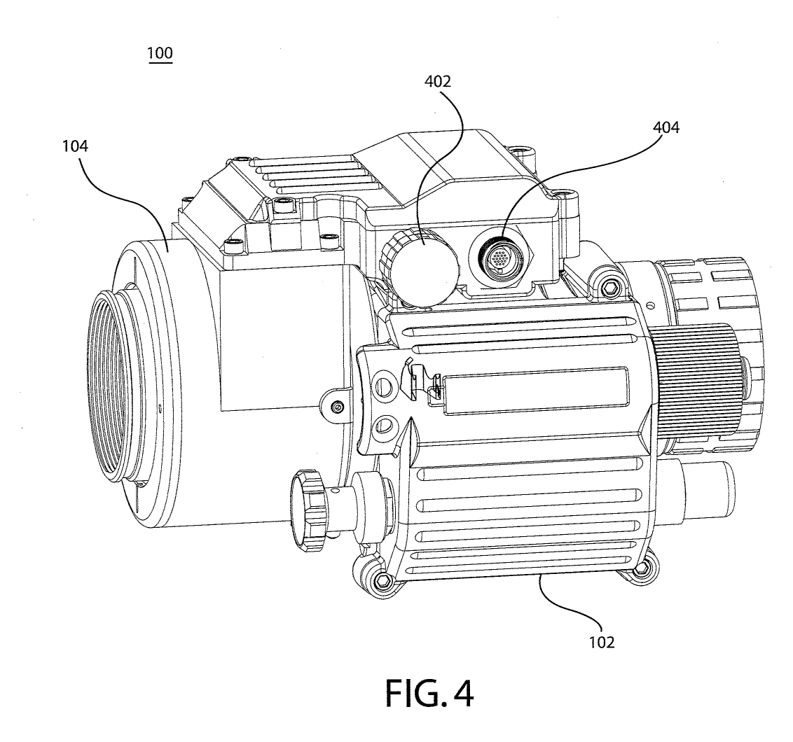

FIG. 4 depicts another perspective view of display device 104 attached to optical device 102. As depicted in FIG. 4, display device 104 includes an on/off button 402 and a port 404 to receive data, transmit data, or a combination of both. In one embodiment, the port 404 may be configured to receive and transmit data via a wire. Additionally, or alternatively, the port 404 may be configured to receive and transmit information wirelessly.

Port 404 may be configured to communicate with any suitable device external to display device 104, e.g., optical device 102, a GPS device, etc. Such suitable external devices will be understood by those having ordinary skill in the art. Port 404 may also be configured to receive and transmit many types of information. Examples of information that may be received and transmitted by port 404 include video information, audio information, and data information. In particular, port 404 may be configured to accept or transmit video information, including video data using VGA (Video Graphics Array), SVGA (Super Video Graphics Array), and CVBS (Composite Video Broadcast Signal) standards.

While preferred embodiments of the invention have been described herein, it will be understood that such embodiments are provided by way of example only. Numerous variations, changes and substitutions will occur to those skilled in the art without departing from the spirit of the invention. It is intended that the appended claims cover all such variations as fall within the spirit and scope of the invention.

What is claimed:

1. An optical apparatus for viewing one or more images, the optical apparatus comprising:
an optical device for enhancing the one or more images and having a surface defining mechanical threads;
a display device which has a display for presenting information, that is removably attached to the optical device, the display device including a surface defining mechanical threads for mating with the mechanical threads of the optical device; and
a lock ring that is mounted to the mechanical threads of the optical device, said lock ring being positioned between the display device and the optical device, wherein the lock ring is rotatably positioned on the mechanical threads of the optical device to move toward and bear on a surface of the display device in order to either limit or prevent the display device from further rotation on the mechanical threads of the optical device.

2. The optical apparatus of claim 1, wherein the display device attaches to the optical device such that the display device is aligned substantially in front of the optical device.

3. The optical apparatus of claim 1, wherein the display device is a head-up device.

4. The optical apparatus of claim 1, wherein the optical device is a night-vision device.

5. The optical apparatus of claim 1, wherein the information presented on the display is light-secure.

6. The optical apparatus of claim 1, wherein the information presented on the display includes navigational information and spatially correlated information.

7. The optical apparatus of claim 1, wherein the display presents augmented reality.

8. The optical apparatus of claim 1, wherein the display is a full color monocular OLED display.

9. The optical apparatus of claim 1, wherein the optical apparatus further comprises an eyepiece removably attached to the optical device.

10. The optical apparatus of claim 1, wherein the display device includes a port for receiving information from and transmitting information to an external device.

11. The optical apparatus of claim 10, wherein the information transmitted by the port includes VGA, SVGA, or CVBS information.

12. The optical apparatus of claim 1, further comprising openings positioned along a circumferences of the lock ring that are used for adjusting the position of the lock ring.

13. A method of retrofitting an optical device comprising the steps of:
coupling a display device, which has a display for presenting information, to the optical device by engaging mechanical threads on the display device with mechanical threads on the optical device; and
rotating a lock ring that is positioned on the mechanical threads of the optical device toward the display device to either limit or prevent the display device from further rotation on the mechanical threads of the optical device.

14. The method of claim 13, prior to the coupling step the method comprises the step of removing an eyepiece from the optical device by rotating the eyepiece to disengage mechanical threads on the eyepiece with the mechanical threads on the optical device.
